(19) United States
(12) Patent Application Publication
(10) Pub. No.: US 2007/0115267 A1
(43) Pub. Date: May 24, 2007

(54) Image Processing Device

(75) Inventor: Koichi MOTOYOSHI, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi (JP)

(21) Appl. No.: 11/470,522

(22) Filed: Sep. 6, 2006

(30) Foreign Application Priority Data
Nov. 18, 2005 (JP) 2005-333612

(51) Int. Cl. G09G 5/00

(52) U.S. Cl. 345/173; 345/156

(57) ABSTRACT

An image processing device with a function setting screen that is easily viewable and operable even when the function setting screens are distributed over a plurality of pages. Image processing functions are set by operating function setting item buttons on the function setting screen. A display control unit displays a page ejection button on each function setting screen in a plurality of pages and switches the page of the function setting screen to another page when the page ejection button displayed on each function setting screen is operated.

### RELATED APPLICATIONS

This application claims priority under 35 USC 119 to Japanese patent application No. 2005-333612, filed on Nov. 18, 2005, which application is hereby incorporated by reference in its entirety.

### BACKGROUND OF THE INVENTION

1. Field of the Invention

The present invention relates to an improved image processing device such as a facsimile device having an operation display screen configured with a touch panel or the like for setting functions.

2. Description of the Related Art

In the prior art, an image processing device such as a facsimile device, a copying machine, or a multi-function peripheral has an operation display unit configured with an operation display screen such as a touch panel, an operation switch or a ten-key keyboard.

In general, in an image processing device of this type, and in particular, in a large device for office use having a reading unit such as a flat bed scanner and a print output unit including a plurality of recording paper cassettes, the ratio of the size of the operation display unit to the size of the entire device is kept small to reduce required space.

Since the display area of the operation display screen is also small, a majority of the function setting screens for setting functions such as copy or facsimile transmission are configured in a menu screen having a plurality of set item buttons and setting screens that are accessible hierarchically from the menu screen for individual setting.

However, since the operation display screen is small, all setting items of the menu often cannot be displayed completely within the display area. In such a case, the setting items must be distributed over a plurality of pages.

In such a menu display distributed over a plurality of pages, it is difficult to determine the number and contents of the setting items.

### SUMMARY OF THE INVENTION

In view of such circumstances, it is an object of the invention to provide an image processing device in which the screen is easily viewable and good in operability even though the display area is small and the screens for setting functions are distributed over a plurality of pages.

Accordingly, one aspect of the invention is an image processing device that sets an image processing function by operation of function setting item buttons on a function setting screen. A display control unit displays page ejection buttons on each function setting screen in a plurality of pages and switches a page of a function setting screen to another page when the page ejection button is operated.

According to a second aspect of the invention, the page ejection button is displayed at an upper, lower, left or right end of the operation display screen and interrupts a part of a peripheral frame of a display frame.

According to a third aspect of the invention, the function setting screen is switched to display a next page via a predetermined animation display mode when the page ejection button is operated.

According to a fourth aspect of the invention, a current page number is displayed on each of the plurality of function setting screens.

Thus, according to the invention, the function setting screen displayed on the operation display screen includes a page ejection button, and a current page of a plurality of pages is cyclically switched to the next page every time the page ejection button is operated. Therefore, even when function setting items are distributed over a plurality of pages, these items can be displayed in sequence with a simple operation, so that the user can easily determine the number or contents of the setting items.

According to the invention, the page ejection button is arranged at an upper, lower, left or right end of the function setting screen, and the end side of the page ejection button is displayed without the frame. Therefore, the display without the frame signals to the user that there are subsequent pages.

According to the invention, when the page ejection button is operated, the next page is displayed by a predetermined display switching mode. Therefore, the fact that the page is being switched to the next page can be visually understood, for example, by deleting the current page once and then displaying a new page as if it moves in from the upper side or the lower side or displaying the new page in a reduced scale at a center of the screen and enlarging gradually when the page ejection button is operated.

According to the invention, the function setting screen also displays the current page number. Therefore, the user can determine which page the user is viewing now.

Other features, elements, processes, steps, characteristics and advantages of the invention will become more apparent from the following detailed description of preferred embodiments of the invention with reference to the attached drawings.

### BRIEF DESCRIPTION OF THE DRAWINGS

FIG. 1A is a perspective view of an image processing device according to the invention;

FIG. 1B is a front view of an operation display unit according to the invention;

FIG. 2 is a block diagram of an internal configuration of the image processing device of the invention;

FIG. 3A, 3B and 3C illustrate a screen configuration, a page ejection operation, and a display switching mode of the function setting screen displayed on the operation display screen of the invention; FIG. 3A shows an initial display of a function setting screen, FIG. 3B shows a state of migration of screen switching at the time of a page ejection operation, and FIG. 3C shows a screen display after page ejection;

FIG. 4 is a flowchart of a switching operation of the image processing device in the invention.

FIG. 5A and 5B illustrate another display switching mode when the page ejection operation of the invention is performed; FIG. 5A shows a function setting screen that appears from the top of the operation display screen, and FIG. 5B shows ae function setting screen that appears from the center of the operation display screen while being gradually enlarged.

### DESCRIPTION OF THE PREFERRED EMBODIMENTS

Referring now to the drawings, embodiments of the invention are described below. Although a facsimile/copy multi-function peripheral is discussed in Examples 1 and 2, the invention can be applied to a single function device such as a facsimile device, a copying machine or a printer, as well as to a multi-function peripheral in which these devices are combined.

### Example 1

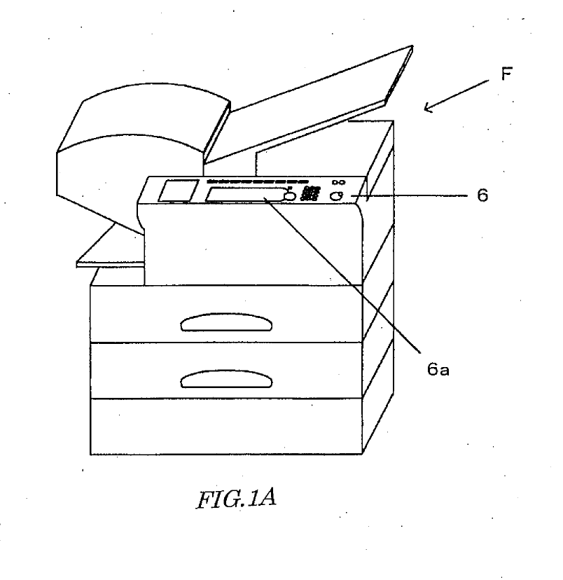

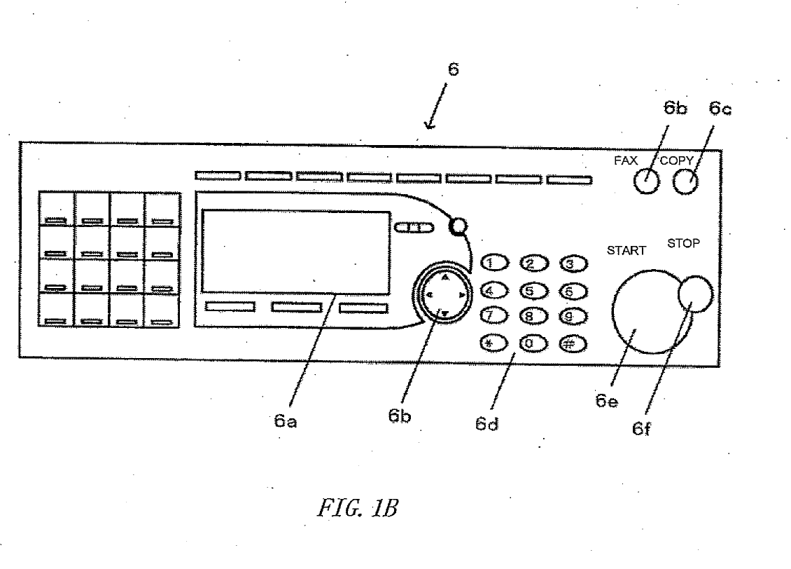

FIG. 1A depicts an image processing device according to the invention, and FIG. 1B depicts an operation display unit according to the invention.

An operation display unit 6 of an image processing device F includes an operation display screen 6a, a facsimile function setting key 6b, a copying machine setting key 6c, a ten-key keyboard 6d, a start key 6e for staring a job, and a stop key 6f for stopping the job or cancelling the setting. Operation display unit 6 is arranged at a position where a user on the front side of unit 6 can easily operate the unit in a standing posture. The operation display screen 6a is configured with a touch panel that the user can operate and display by touching with his/her finger.

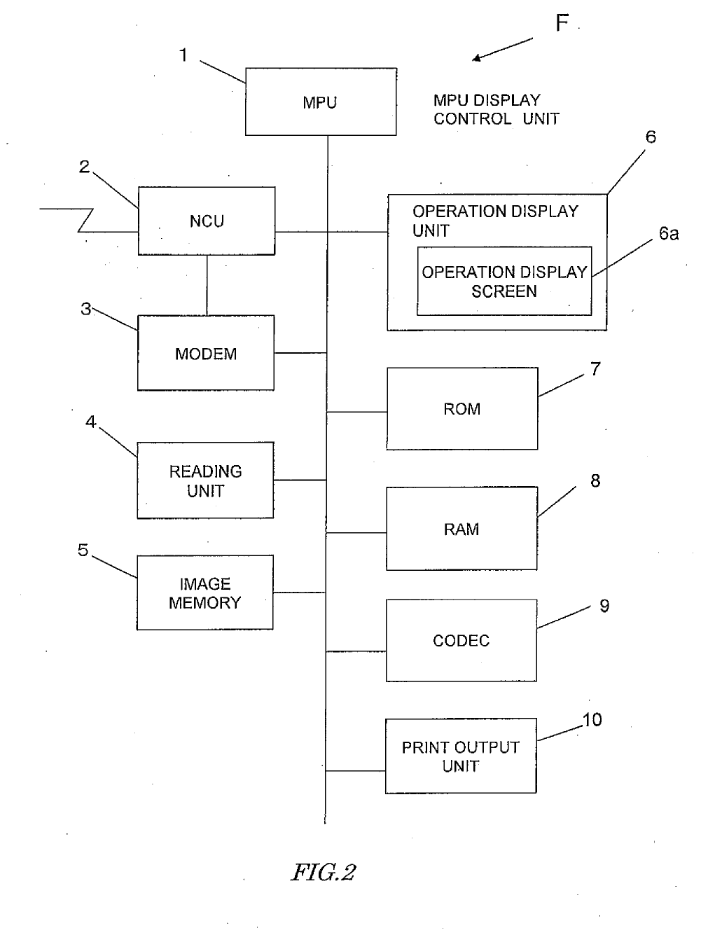

FIG. 2 is a block diagram of an internal configuration of image processing device F.

Image processing device F includes an MPU 1, an NCU 2, a modem 3, a reading unit 4, an image memory 5, the operation display unit 6, a ROM 7, a RAM 8, a CODEC 9, in which various programs or constant data are stored, and a print output unit 10.

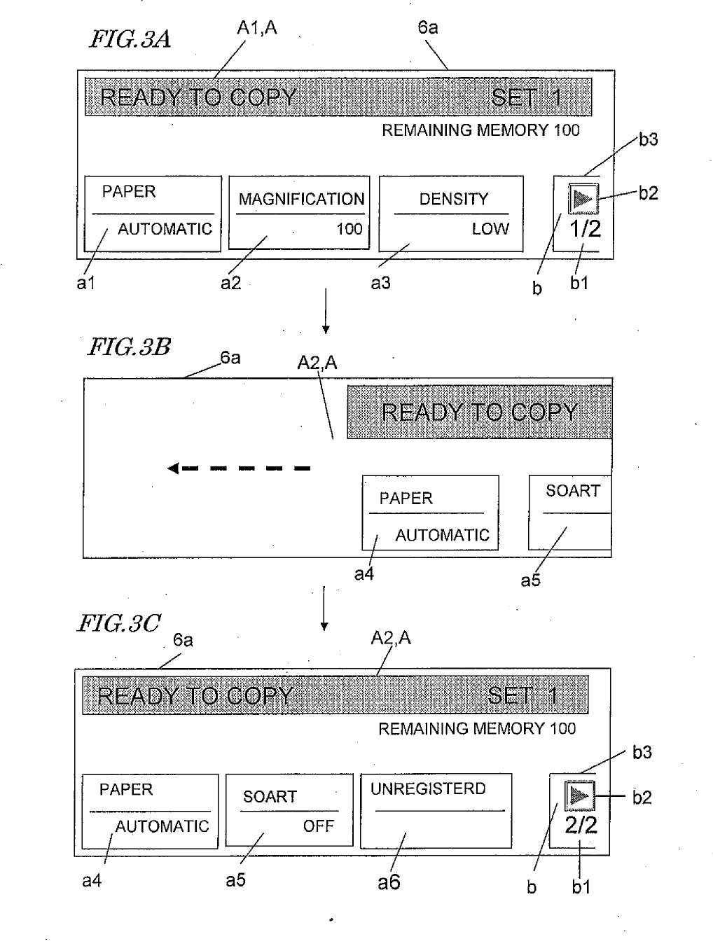

The MPU 1 constitutes a display control unit for controlling these respective units according to respective programs and displaying a function setting screen A (see FIG. 3) including a plurality of pages on operation display screen 6a. NCU 2 receives and sends network control over a public line N, and modem 3 modulates and demodulates transmission data. Accordingly, facsimile transmission is performed.

Reading unit 4 includes a flat bed scanner (not shown) and the like that reads an original document image and outputs binarized image data to image memory 5.

Operation display unit 6 includes operation display screen 6a configured with a touch panel or the like as described in conjunction with FIG. 1.

Various setting data or variable data are stored in RAM 8. CODEC 9 encodes read image data by systems such as MH, MR, and MMR for transmission, and decodes received image data for print output.

Print output unit 10 outputs the read image or the received image to recording paper set in a manual paper feed tray or cassette.

Image recording device F has a basis facsimile transmission function to encode image data read by reading unit 4 in sequence, store the same once in image memory 5, and then transmit the same to a destination facsimile device (not shown) via modem 3 and NCU 2. Upon reception of image data, device F stores the received image data in image memory 5, reads and decodes the same in sequence, and prints and outputs by print output unit 10. Device F also has a function to print output image data of an original document read by reading unit 4 to recording paper.

Image processing device F is configured such that functions such as the facsimile transmission and copying functions can be set on function setting screen A by operating function setting keys 6b, 6c to display function setting screens A, operating various setting item buttons provided in the screen, then , switching to screens in the lower hierarchy, in which individual items can be set on these screens.

Since current setting details are displayed on the buttons on respective setting items, the current setting details can be recognized without switching the screens to the lower hierarchy every time. Alternatively, the buttons may be adapted to switch the setting details every time when they are operated without switching the screens to the lower hierarchy.

The respective function setting screens A display the setting items in the menu form. However, since it is necessary to display a number of setting item buttons on the operation display screen 6a, the function setting screens A are divided and displayed in a plurality of pages.

A copying function, for example, includes “sheet selection”, “magnification”, “density”, “image quality”, and “sort” as setting items. Function setting screen A includes two pages; a first page including the three items of “sheet selection”, “magnification” and “density”, and a second page including the two items of “image quality” and “sort”, which are switched and displayed by the switching operation.

The invention is characterized by the screen configuration of the function setting screen A including the plurality of pages, the page ejection operation, and the display switching mode.

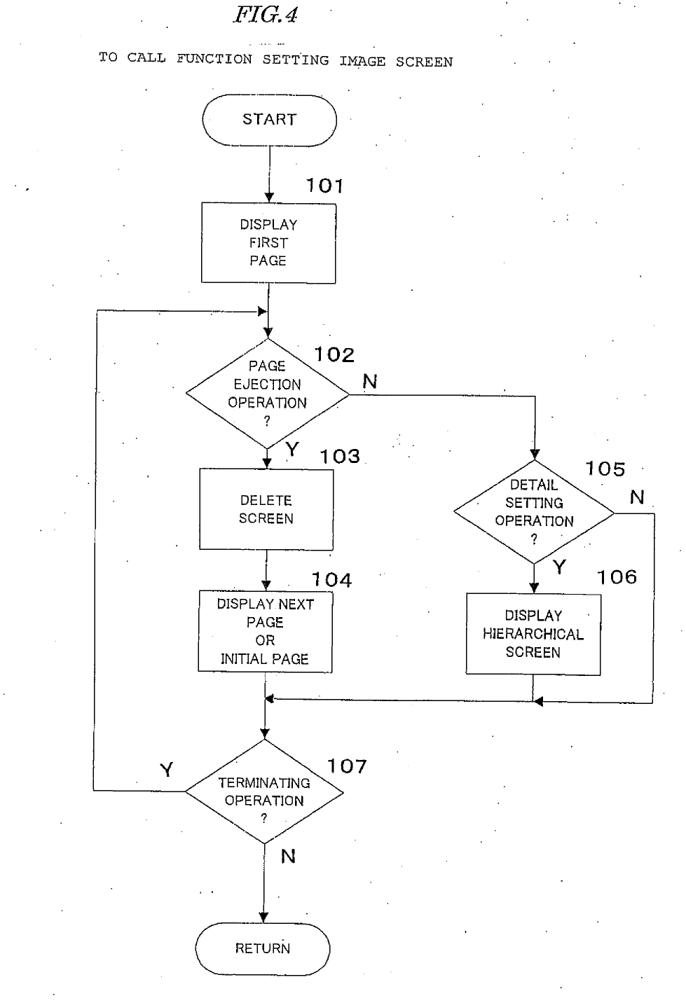

Referring now to FIGS. 3 and 4, the display switching operation of function setting screen A is described.

FIGS. 3A, 3B and 3C illustrate a screen configuration, the page ejection operation, and the display switching mode of function setting screen A. FIG. 3A shows an initial display of the function setting screen, FIG. 3B shows a state of migration of screen switching at the time of the page ejection operation, and FIG. 3C shows a screen display after the page ejection, respectively. The broken line arrow in FIG. 3B indicates the direction of movement of display of the screen, and is not displayed on the screen. Although in this example the screen moves from right to left when being switched, the screen may also move downward from the top when being switched, as will be described later.

FIG. 4 depicts a display switching operation of function setting screen A.

Upon detection of calling of function setting screen A by copy function setting key 6c, MPU display control unit 1 displays a screen A1 of a first page including various setting item buttons a1, a2, a3 for “sheet selection”, “magnification” and “density” (Step 101 in FIG. 4).

In screen A1, a page ejection button b on a right side of the screen includes an indication “1/2” that indicates the current page number/the number of total pages (b1), and an arrow b2 that shows that there exists a next page in an eye-friendly manner. A peripheral frame b3 of page ejection button b is displayed without a frame at the right end thereof.

When page ejection button b is operated in this state, for example, the screen is once deleted, and a screen A2 of the second page appears from the right side of the display area, as shown in FIG. 3. Screen A2 is displayed in a predetermined switching animation display mode in which the screen is moved in the direction of the broken arrow to display respective setting item buttons a4 and as for “image quality” and “sort”, an unregistered free button a6, and a page ejection button b including “2/2” which indicates the current page number/the total number of pages (b1) (FIG. 3B, 3C and Step S102 to 104 in FIG. 4). In the second page, similar to the first page, peripheral frame b3 of page ejection button b is displayed with the end side removed and without the frame.

When buttons a1 to as of the respective setting items are operated without the operation of the page ejection button b, the screens of the lower hierarchy (not shown) in which the detailed setting can be made therein respectively are displayed (Steps S107, 108 in FIG. 4).

In a state in which the page ejection operation is performed in a state in which the second page is displayed, the initial page is displayed again (Steps S102 to 104 in FIG. 4).

In other words, the function setting screen A including the plurality of pages is cyclically and repeatedly switched in a forward direction to another page every time when the page ejection operation is performed until an operation to terminate the corresponding screen such as an operation of the start key 6e, an operation of the stop key 6f, or an operation to switch to another screen (Steps S102 to 104, 107 in FIG. 4).

Since the switching of the display of function setting screen A including the plurality of pages is performed cyclically every time page ejection button b is operated, even though function setting screen A is distributed in a plurality of pages, these pages can be displayed in sequence with a simple operation, so that the user can easily figure out the number or the contents of the setting items.

Since page ejection button b is arranged at an upper, lower, left or right end of function setting screen A and an end side of peripheral frame b3 of page ejection button b is displayed without the frame, the user can recognize at a glance that there exists a screen continued to the current page.

In addition, since the next page screen is displayed in the predetermined display switching mode when page ejection button b is operated, the user visually recognizes that the operation of switching the page to the next page is in progress.

The display switching by page ejection may be done in both normal and reverse directions. By arranging page ejection buttons b on the right and left ends of function setting screen A and operating either one of these, switching to the next page and to the previous page is achieved. In this case, the cyclic display switching may be enabled or disabled.

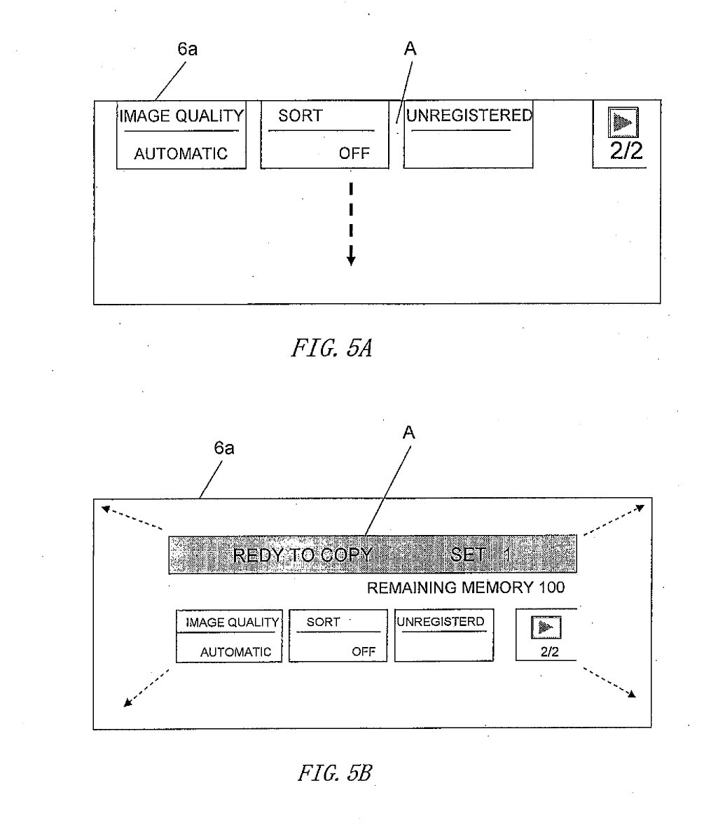

FIGS. 5A and 5B illustrate another switching display mode of this invention. FIG. 5A shows an example in which the function setting screen A appears from the top of the operation display screen 6a, and FIG. 5B shows an example in which the function setting screen A appears from the center of the operation display screen 6a while being gradually enlarged. The broken line arrows indicate the direction of movement of display of the screen, and are not displayed in the screen.

It is also possible to delete the current page when the page ejection operation is done, then display a phrase such as “loading the next page. . . ” at a center or the like of the operation display screen 6a for about one second, and then switch to the next page.

While the invention has been described with respect to preferred embodiments thereof, it will be apparent to those skilled in the art that disclosed invention may be modified in numerous ways and may assume many embodiments other than those specifically set out and described above. Accordingly, it is intended by the appended claims to cover all modifications of the invention that fall within the true sprit and scope of the invention.

What is claimed is:

1. An image processing device comprising:
an operation display unit having an operation display screen;
a setting unit for setting an image processing function by operating function setting item buttons on a function setting screen displayed on the operation display screen; and
a display control unit that displays a page ejection button on each function setting screen in a plurality of pages and switches a page of the function setting screen to another page when the page ejection button is operated.

2. The image processing device according to claim 1, wherein the page ejection button is displayed at an upper, lower, left or right end of the operation display screen and interrupts a part of a peripheral frame of a display frame.

3. The image processing device according to claim 1, wherein the function setting screen is switched to display a next page via a predetermined animation display mode when the page ejection button is operated.

4. The image processing device according to claim 2, wherein the function setting screen is switched to display a next page via a predetermined animation display mode when the page ejection button is operated.

5. The image processing device according to claim 1, wherein a current page number is displayed on each of the plurality of function setting screens.

6. The image processing device according to claim 2, wherein a current page number is displayed on each of the plurality of function setting screens.

7. The image processing device according to claim 3, wherein a current page number is displayed on each of the plurality of function setting screens.

8. The image processing device according to claim 4, wherein a current page number is displayed on each of the plurality of function setting screens.

9. A method for displaying a menu of functions in an image processing device comprising:
displaying the functions on a display of the image processing device over a plurality of pages; and
providing a page ejection button on each of the plurality of pages to switch the display from a current page to a next page.

10. The method according to claim 9, and further comprising displaying the page ejection button at an upper, lower, left or right side of the display.

11. The method according to claim 10, and further comprising displaying the page ejection button with a partially open peripheral frame to signal that additional pages exist.

12. The method according to claim 10, and further comprising displaying the page ejection button with a current page number and a total number of pages.

13. The method according to claim 9, and further comprising switching the display by deleting the current page and migrating the next page in from a left, right, upper or lower side of the display.

14. The method according to claim 9, and further comprising switching the display by deleting the current page and displaying the next page in a reduced scale at a center of the display and gradually enlarging the next page.

15. The method according to claim 9,and further comprising:
providing a first page ejection button on a right side of the display;
providing a second page ejection button on a left side of the display;
switching the display to the next page when the first page ejection button is operated; and
switching the display to a previous page when the second page ejection button is operated.

16. An image processing device with a plurality of functions comprising:
a display screen; and
means for displaying the plurality of functions in a plurality of pages on the display screen; and
means for indicating in a currently displayed page that additional pages exist and for switching the display screen to another page.

17. An image processing device according to claim 16, wherein the display screen is a touch panel, and the means for indicating and means for switching comprises a page ejection button on the touch panel.

18. An image processing device according to claim 17, wherein operation of the page ejection button causes an animated switching from the currently displayed page to another page.

19. An image processing device according to claim 18, wherein the page ejection button is surrounded by a partially open frame to indicate that the additional pages exist.

20. An image processing device according to claim 19, wherein the page ejection button includes a current page number and a total page count.
